(19) United States
(12) Patent Application Publication
(10) Pub. No.: US 2007/0284446 A1
(43) Pub. Date: Dec. 13, 2007

(54) PORTABLE ELECTRONIC APPARATUS AND WARNING METHOD THEREOF

(76) Inventors: Mou-Ming Ma, Taipei Hsien (TW); Ming-Hsiung Liu, Taipei Hsien (TW); Po-Cheng Chen, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(21) Appl. No.: 11/309,022

(22) Filed: Jun. 9, 2006

(51) Int. Cl. G06K 7/08

(52) U.S. Cl. 235/451

(57) ABSTRACT

A portable electronic apparatus and a warning method thereof are provided. By detecting an external tag by a wireless identification unit disposed in the portable electronics apparatus, the present invention can remind user to prevent from losing the portable electronics apparatus and ensure security of personal data and privacy of the user. Further, the portable electronic apparatus can provide the function of preventing the valuables from being lost by disposing the tag(s) on the valuables.

### BACKGROUND OF THE INVENTION

1. Field of Invention

The present invention relates to an electronic apparatus. More particularly, the present invention relates to a portable electronic apparatus which provides warning function by detecting a target tag and a warning method thereof.

2. Description of Related Art

Presently, electronic apparatus and wireless communication apparatus of various functions are playing a very important role in our daily life. For the convenience of portability, the volume of electronic apparatus is getting smaller and smaller, thus different types of portable electronic apparatuses, such as Personal Digital Assistants (PDAs) and notebook computers, are invented. For example, nowadays mobile phones have become very popular, and their functions have become more and more diversified. In their work or daily life, people hardly go without mobile phones. The users usually record the contact information of their friends, calendar, or other data in the mobile phones, so that they can be reminded or provided with the information any time.

However, when a wireless communication apparatus or a portable electronic apparatus is lost, it's not only a loss of valuables but also a threat to the security of personal data and privacy. Therefore, how to prevent the loss of a wireless communication apparatus or a portable electronic apparatus has to be solved.

### SUMMARY OF THE INVENTION

The present invention is directed to a portable electronic apparatus and the warning method thereof, which provides the warning function by detecting an external tag to remind the user to prevent from losing the portable electronic apparatus and to further ensure the security of personal data and privacy. Further, the portable electronic apparatus can provide the function for preventing the valuables from being stolen or lost by disposing the tag(s) on the valuables.

Based on the aforesaid or other objects, the present invention provides a portable electronic apparatus, including a controlling unit, a database, a wireless communication unit, and a wireless identification unit. The controlling unit controls the portable electronic apparatus. The wireless communication unit is coupled to the controlling unit to provide wireless communication function. The wireless identification unit is coupled to the controlling unit to detect at least one external tag in a wireless manner and transmit the characteristics of the tag to the controlling unit. The database is coupled to the controlling unit and is used for pre-recording the characteristics list of at least one target tag. Wherein, the controlling unit searches in the database to determine whether the tag is a target tag.

According to another aspect of the present invention, a warning method of a portable electronic apparatus is provided. The warning method includes providing a database for pre-recording the characteristics list of at least one target tag, detecting at least one external tag of a portable electronic apparatus in a wireless manner, and searching in the database to determine whether the tag is a target tag, and if any target tag in the database cannot be detected, giving a corresponding warning.

According to an aspect of the present invention, a portable electronic apparatus including a controlling unit, a database, and a wireless identification unit is provided. The controlling unit controls the portable electronic apparatus. The database is coupled to the controlling unit to pre-record the characteristics of at least one target tag. The wireless identification unit is coupled to the controlling unit to detect at least one external tag in a wireless manner and transmit the characteristics of the tag to the controlling unit. Wherein, the controlling unit searches in the database to determine whether the tag is a target tag. When any target tag recorded in the database cannot be detected by the wireless identification unit, the controlling unit controls the portable electronic apparatus to give a corresponding warning.

By disposing a wireless identification unit in the portable electronic apparatus, the warning function is provided by detecting an external tag(s) in a wireless manner. The present invention can remind the users to prevent from losing the portable electronic apparatus and further ensure the security of personal data and privacy. In other words, when the portable electronic apparatus is away from the tag on the user so that the portable electronic apparatus cannot detect the target tag, the portable electronic apparatus gives a warning instantly to remind the user to avoid losing the portable electronic apparatus. Further, the portable electronic apparatus provides the function of preventing valuables from being stolen or lost by disposing a tag on the valuables. In other words, when the valuables disposed with a tag is away from the portable electronic apparatus carried by the user and the portable electronic apparatus cannot detect the target tag, the portable electronic apparatus would give a warning instantly to remind the user to prevent from losing the valuables.

In order to the make the aforementioned and other objects, features and advantages of the present invention comprehensible, a preferred embodiment accompanied with figures is described in detail below.

### BRIEF DESCRIPTION OF THE DRAWINGS

The accompanying drawing is included to provide a further understanding of the invention, and is incorporated in and constitutes a part of this specification. The drawing illustrates embodiment of the invention and, together with the description, serves to explain the principles of the invention.

FIG. 1 is a diagram illustrating a wireless communication apparatus/portable electronic apparatus according to an embodiment of the present invention.

FIG. 2 is a flowchart illustrating a warning method of a portable electronic apparatus according to an embodiment of the present invention.

### DESCRIPTION OF EMBODIMENTS

For the convenience of description, a wireless communication apparatus (such as a mobile phone) is described as an embodiment of the present invention in the following. However the embodiments described below should not be construed as restrictions of the present invention. It should be understood by those skilled in the art that the spirit and scope of the present invention and the teaching of the embodiments described below may be applied to any portable electronic apparatus.

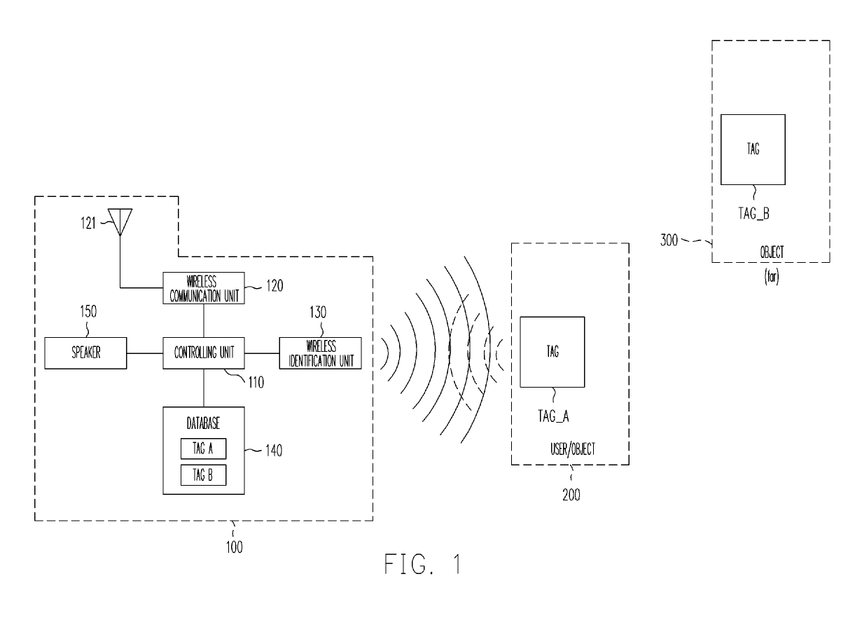

FIG. 1 is a diagram illustrating a wireless communication apparatus/portable electronic apparatus according to an embodiment of the present invention. Referring to FIG. 1, an embodiment of the portable electronic apparatus is described with the mobile phone 100 as an example. The mobile phone 100 includes the controlling unit 110, the wireless communication unit 120, the wireless identification unit 130, the database 140, and the speaker 150. The mobile phone 100 provides the wireless communication function through the antenna 121 with the wireless communication unit 120. The controlling unit 110 is coupled to the wireless communication unit 120. The controlling unit 110 controls various operations of the portable electronic apparatus. The database 140 is coupled to the controlling unit 110. The database 140 can pre-record the characteristics lists of target tags, such as the characteristics of the target tags TAG_A and TAG_B in FIG. 1.

The controlling unit 110 is further coupled to the wireless identification unit 130. The wireless identification unit 130 detects at least one external tag in a wireless manner. In the present embodiment, the wireless identification unit 130 detects external tag(s) using, for example, the Radio Frequency Identification (RFID) mechanism. When the wireless identification unit 130 cannot detect the tag whose characteristics is recorded in the database, the controlling unit 110 controls the mobile phone 100 to give a warning. In FIG. 1, for example, when the wireless identification unit 130 detects the tag TAG_A but cannot detect the tag TAG_B, the controlling unit 110 controls the mobile phone 100 to give a warning through the speaker 150.

Alternatively, after the wireless identification unit 130 detects all external tags continuously (or discontinuously) in a wireless manner (such as RFID), the characteristics of each detectable tag are transmitted to the controlling unit 110. After that, the controlling unit 110 searches in the database 140 to determine whether a tag is a target tag. When any target tag recorded in the database 140 cannot be detected by the wireless identification unit 130, the controlling unit 110 controls the speaker to give a corresponding warning according to the undetected target tag.

In the present embodiment, the induction manner between the wireless identification unit 130 and the tag may be inductive coupling, backscatter coupling, or other induction manners. In addition, a tag may be provided with required power by wireless transmission power from the wireless identification unit 130, thus the volume of the tag may be reduced since it does not need additional power. Certainly, those skilled in the art may apply power (such as solar power) to the tag according to the requirement.

The working frequencies of the RFID range from low frequency to high frequency (e.g. 134.2 KHz, 13.56 MHz, UHF band of 300 MHz˜1 GHz, and SHF band of 2.4 GHz), and the inductive distances are also different. For example, the inductive distances for the RFID at working frequencies of 134.2 KHz and 13.56 MHz are from about 5 cm to 70 cm, and it can be up to 5 meters at frequency of UHF. Thus the appropriate detecting frequency can be chosen according to the requirement.

The aforesaid tag (such as the tag TAG_A) can be carried by the user 200, and the other tag (such as the tag TAG_B) can be disposed on the object 300. When the mobile phone 100 is away from the user 200 (i.e. from the tag TAG_A) farther than the inductive distance such that the wireless identification unit 130 cannot detect the tag TAG_A, the controlling unit 110 gives a warning with the speaker promptly to remind the user to prevent from losing the mobile phone 100. Here the object 300 may be, for example, valuables of the user. When the object 300 disposed with a tag TAG_B is away from the user 200 (i.e. from the mobile phone 100) farther than the inductive distance, such that the wireless identification unit 130 cannot detect the tag, the controlling unit 110 immediately gives a warning through the speaker 150 to remind the user to check whether the object 300 is stolen or lost.

Furthermore, when any target tag recorded in the database 140 cannot be detected by the wireless identification unit 130, the controlling unit 110 controls the mobile phone 100 to prohibit any access. Thus the security of personal data and privacy can be ensured.

Although only two tags is illustrated in FIG. 1, the number of tags should not be restricted hereby. The wireless identification unit 130 may give search signals at fixed intervals or unfixed intervals, after that all the tags around the wireless identification unit 130 give responsive signals. Accordingly, one or more tags may be disposed on one or more objects respectively. Here the objects 200 and 300 may be, for example, valuables of the user. When the object 200 and/or 300 disposed with the target tags TAG_A and TAG_B respectively is away from the user (i.e. from the mobile phone 100) farther than the inductive distance, such that the wireless identification unit 130 cannot detect the target tag TAG_A or TAG_B, the controlling unit 110 immediately gives a warning through the speaker 150 to remind the user to check whether the object 200 and/or 300 are stolen or lost.

Furthermore, in the present embodiment, different warning sounds and volumes can be configured in accordance with different objects (i.e. different tags) respectively. Thus, the user can be instantly notified of the object by the warning sound without checking which object is possibly beyond reach.

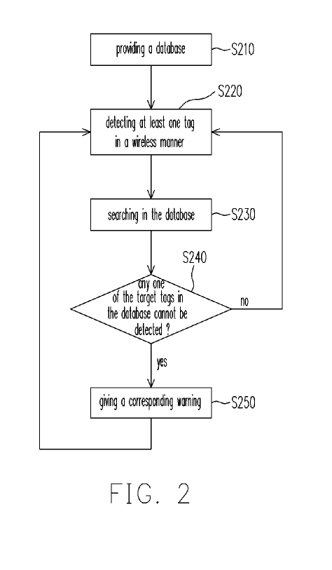

FIG. 2 is a flowchart illustrating a warning method of a portable electronic apparatus according to an embodiment of the present invention. Referring to FIG. 2, the warning method of a portable electronic apparatus comprise following steps. At step S210, a database 140 for pre-recording characteristics of at least one target tag is provided. The wireless identification unit 130 detects at least one tag in a wireless manner, such as RFID, at step S220. The controlling unit 110 searches in the database 140 to determine whether the detected tag is a target tag (step S230). If any one of the target tags in the database does not be detected (step S240), then making a corresponding warning (step S250) and return to the step S220. If all the target tags in the database can be detected (step S240), then return to the step S220.

In summary, by detecting an external tag by a wireless identification unit disposed in the portable electronic apparatus, the present invention can remind the user to prevent from losing the portable electronic apparatus and ensure security of personal data and privacy of the user. Further, the portable electronic apparatus can provide the function for preventing the valuables from being lost or stolen by disposing the tag(s) on the valuables.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A portable electronic apparatus, comprising:
a controlling unit, for controlling the portable electronic apparatus;
a wireless communication unit coupled to the controlling unit, for providing the wireless communication function;
a wireless identification unit coupled to the controlling unit, for detecting at least one tag in a wireless manner, receiving characteristic of the least one tag, and transmitting the characteristic to the controlling unit; and
a database coupled to the controlling unit, for pre-recording characteristic of at least one target tag;
wherein the controlling unit searches in the database to determine whether the detected tag is one of the target tag.

2. The portable electronic apparatus as claimed in claim 1, wherein the controlling unit controls the portable electronic apparatus to issue a corresponding warning according to a target tag when the target tag whose characteristics is recorded in the database does not be detected by the wireless identification unit.

3. The portable electronic apparatus as claimed in claim 2, wherein when a particular target tag recorded in the database does not be detected by the wireless identification unit, access to the portable electronic apparatus is prohibited.

4. The portable electronic apparatus as claimed in claim 2, wherein the wireless manner is a Radio Frequency Identification (RFID) mechanism.

5. The portable electronic apparatus as claimed in claim 1, wherein the portable electronic apparatus is a wireless communication apparatus.

6. A warning method of a portable electronic apparatus, comprising:
providing a database for pre-recording characteristics of at least one target tag;
detecting at least one tag in a wireless manner;
searching in the database to determine whether the detected tag is a target tag; and
making a corresponding warning if any one of the target tags in the database does not be detected.

7. The warning method of a portable electronic apparatus as claimed in claim 6, further comprising:
prohibiting access to the portable electronic apparatus if a particular target tag does not be detected.

8. The warning method of a portable electronic apparatus as claimed in claim 6, wherein the wireless manner is a Radio Frequency Identification (RFID) mechanism.

9. The warning method of a portable electronic apparatus as claimed in claim 6, wherein the portable electronic apparatus is a wireless communication apparatus.

10. A portable electronic apparatus, comprising:
a controlling unit, for controlling the portable electronic apparatus;
a database coupled to the controlling unit, for pre-recording the characteristics of at least one target tag; and
a wireless identification unit coupled to the controlling unit, for detecting at least one tag in a wireless manner, receiving characteristic of the least one tag and transmitting the characteristic to the controlling unit;
wherein the controlling unit searches in the database to determine whether the tag is one of the target tag; and
when any target tag in the database does not be detected by the wireless identification unit, the controlling unit controls the portable electronic apparatus to issue a corresponding warning.

11. The portable electronic apparatus as claimed in claim 10, wherein when a particular target tag recorded in the database does not be detected by the wireless identification unit, access to the portable electronic apparatus is prohibited.

12. The portable electronic apparatus as claimed in claim 10, wherein the wireless manner is a Radio Frequency Identification (RFID) mechanism.

13. The portable electronic apparatus as claimed in claim 10, wherein the portable electronic apparatus is a wireless communication apparatus.
